(19) United States
(12) Patent Application Publication
(10) Pub. No.: US 2011/0311930 A1
(43) Pub. Date: Dec. 22, 2011

(54) PROCESS AND CONTROL SYSTEM FOR A CARBONACEOUS BLOCK BAKING FACILITY

(75) Inventors: Yann El Ghaoui, Dunkerque (FR); Magali Gendre, Sainte Marie de Cuines (FR); Francois Ordronneau, Chambery (FR); Jean-Paul Kreuwen, Bassens (FR)

(73) Assignee: RIO TINTO ALCAN INTERNATIONAL LIMITED, Montreal (CA)

(21) Appl. No.: 13/142,023

(22) PCT Filed: Dec. 8, 2009
(86) PCT No.: PCT/FR2009/001394

§ 371 Date: Sep. 7, 2011

(30) Foreign Application Priority Data
Dec. 24, 2008 (FR) 0807452

(51) Int. Cl. F27B 13/14; F27D 21/00

(52) U.S. Cl. 432/32; 432/1; 432/36

(57) ABSTRACT

The furnace of the facility includes partitions in which hot gases from the baking of carbonaceous blocks circulate, and heating ramps (21, 22, 23) revolving in relation to the furnace, equipped with burners or fuel injectors. Gas circulation lines (24) are defined along the partitions between an air blowing leg (20) and a corresponding gas suction leg (12). To detect even partial partition blocking of a partition, the process includes, on a continuous basis:
a. for each gas circulation line, continuous recording of at least one of the following measured parameters: temperature, pressure, flow, oxygen concentration and carbon monoxide concentration;
b. evaluation of at least one factor from the measured parameters;
c. comparison of this factor with a corresponding reference value;
d. emission of a malfunctioning signal when the comparison between the factor and the corresponding reference value does not meet with the predefined safety criteria.

The present invention relates to a process and a control system for a carbonaceous block baking facility, particularly carbon anodes used for the production of aluminum by electrolysis.

The invention aims at detecting any malfunctioning related to a combustion problem, and particularly combustion problems either through lack of fuel, or through too low an ignition temperature, or through too large a quantity of fuel (in relation to the combustive).

Metallic aluminum is produced industrially by electrolysis using the Hall-Héroult process. For this purpose, cells are provided comprising a cathode unit at the bottom and containing an electrolyte bath in which carbon anodes are partially immersed.

The anodes are made of molded carbonaceous blocks which are baked in furnaces. It is known that these furnaces include an insulated external enclosure that may comprise transverse walls defining chambers. The furnaces are equipped with hollow heating partitions extending longitudinally, forming between them lengthened cells designed to receive the carbonaceous blocks to be baked.

Once the carbonaceous blocks are piled up in these cells, and before baking, a granular or powdery filling material called “packing coke” is introduced into the cells. The packing coke is used to protect the anodes during baking, in particular against oxidation which they might undergo because of the high baking temperature (about 1200° C.).

Baking is achieved by means of hot gases circulating within the partitions. These gases include air blown into the partitions by means of blowing legs and a primary fuel—liquid or gas—injected into the partitions, and the gas produced by anode baking (volatile hydrocarbons), which is used as a secondary (complementary) fuel. The primary fuel may be injected by heating ramps comprising one or more burners, or one or more injectors. In this latter case, the fuel burns in the furnace because of the high temperature within it. The injected gases and/or products are then sucked from the partitions by means of suction legs.

During a baking cycle, the heating ramps are gradually moved in relation to the furnace, so that each anode load, in a given part of the furnace, is successively preheated, baked, and cooled. This type of furnace is known as a “ring furnace”. Once the anodes have been cooled, they are removed from the cells.

If a furnace partition is completely or partly blocked (for example because of infiltration of packing coke) or loses its shape (because of the high temperature in the furnace during baking and the successive heating and cooling cycles), or if the baking zone is subjected to strong infiltrations or exfiltrations of air (infiltrations caused either by a problem when installing the equipment, or by the state of the furnace and/or its equipment), sweeping of the corresponding line of partitions greatly decreases or even becomes nonexistent. Sweeping is the circulation of gas in and through the hollow partitions. This type of malfunctioning is called partition blocking. But the primary fuel continues to be injected and volatile materials continue to be produced by the carbonaceous blocks during baking. Without sweeping, fuel and/or volatile materials accumulate in the dead zones. Any oxygen entering the system may then cause an explosion. This problem is even more serious as the production rate for anodes in the baking plants is very high, the furnaces and various equipment required for the anode baking operation functioning on a permanent basis.

For safety and security reasons, various control methods have naturally already been put into place. However, no reliable automatic means exists to date that can quickly detect a partition sweeping problem, with a view to triggering safety measures. Moreover, global regulation systems used generally do not make it possible to detect and confirm a sweeping problem occurring locally in a partition. Only specific supervision by the furnace operators may make it possible to reliably detect a partition sweeping problem.

The present invention aims at correcting the drawbacks mentioned above, by providing a process and a system for detecting malfunctioning of the furnace related to a problem of combustion which meets with severe safety standards, which is reliable, and which makes it possible to very quickly detect a sweeping problem on a furnace partition.

For this purpose, the invention relates to a control process for the operating of a carbonaceous block baking facility, the facility including:

a furnace which comprises hollow longitudinal partitions in which hot baking gases can circulate, and defining between them cells to receive the carbonaceous blocks to be baked,

and a heating system revolving in relation to the furnace, which comprises an upstream ramp of several legs blowing air into the various partitions, a downstream ramp of several legs sucking gas from the various partitions and, between said blowing and suction ramps, at least one heating ramp equipped with at least one burner or at least one fuel injector per partition;

basically longitudinal gas circulation lines being defined in this way along the partitions between a blowing leg and a corresponding suction leg.

According to a general definition of the invention, with the aim of detecting malfunctioning related to a problem of combustion and more particularly of detecting even partial partition blocking, the process includes:

a) for each gas circulation line, continuous recording, on at least one given point of said the gas circulation line, of at least one of the following measured parameters: temperature, pressure, flow, oxygen concentration and carbon monoxide concentration;

b) continuous evaluation of at least one factor from the measured parameter(s);

c) continuous comparison of this factor with a corresponding reference value

d) emission of a malfunctioning signal when the comparison between the factor and the corresponding reference value does not meet with the predefined safety criteria.

In practice, the process is designed to take one or more continuous measurements of physical parameters for each line of partitions, and not in an overall single or localized way. Next, a relevant factor is evaluated. In certain embodiments, this factor may be calculated and, in other embodiments, this factor may be the measured parameter directly, no calculation being then necessary. This factor may correspond to an operating index for the furnace.

This factor is then compared with a reference value. This may be either predetermined (for example according to the operating conditions) or calculated (it may in particular be the average of the other identical factors on the other gas circulation lines). If the factor under consideration is not in the predetermined safety range (for example if it is below the low threshold value or above the corresponding high threshold value, or if it deviates too much from this reference value), then a malfunctioning signal is emitted and, preferably, operations designed to safeguard the facility are set in motion as a reaction to this signal.

The invention allows for the possibility of combining various factors and the related reference values to increase the safety of the facility. In this case, the various safety measures (measurement, calculation, and comparison with a reference value) are preferably independent of each other.

The invention in particular makes it possible to detect a sweeping problem on a line of partitions, i.e. a problem of gas circulation in and through the hollow partitions.

It should be noted that the terms “upstream” and “downstream” are defined in relation to the direction of the fire, which is also the direction of gas flow.

The invention relates as much to furnaces comprising at least one 5 transverse wall as to those which do not have any.

Advantageously, at least two parameters may be measured, each one in a distinct zone of the furnace, chosen from:

a zone known as a natural pre-heating (PN) zone, located upstream of the heating ramp(s);

a zone known as a heating zone (HR), located under the heating ramp(s);

a zone known as a blowing zone (BL) located downstream of the heating ramp(s).

This makes it possible to improve detection of malfunctioning, whatever the zone of the furnace where it occurs.

For example, at least one parameter is measured in a natural preheating zone (PN) or a heating zone (HR), and at least one parameter is measured in a blowing zone (BL).

According to a particularly advantageous embodiment, the parameter measured in the blowing zone (BL) is the pressure at the level of a point zero ramp which is arranged so as to substantially set the pressure at the junction of the blowing zones (BL) and of the heating zones (HR) to atmospheric pressure.

It may be decided that at least one evaluated factor is a measured parameter, which in particular makes it possible to avoid any calculation. As a variant or complement, at least one evaluated factor may be a function at least two parameters, for example the product and/or the quotient of at least two parameters.

At least one factor can be chosen from: T, T/P, P, Q, Q×T, Q×T/P, H=Q.Cp.(T−10), H/P, P0, [O2], [CO], where:

T is the temperature at a point on a gas circulation line;

P is the pressure at a point on a gas circulation line;

Q is the gas flow rate at a point on a gas circulation line;

Cp is the heat-storage capacity of the gas;

T0 is a reference temperature;

P0 is the pressure measured at the level of a point zero ramp which is arranged to substantially set the pressure at the junction of the blowing zones (BL) and of the heating zones (HR) to atmospheric pressure;

[O2] is the oxygen concentration;

[CO] is the carbon monoxide concentration.

According to an advantageous embodiment, at least two distinct factors are evaluated, and each of these factors is compared to a distinct corresponding reference value. In this case there are therefore safety criteria on each of these factors, giving at least two safety criterion, which makes it possible to improve malfunctioning detection still further.

According to a preferred, particularly robust and easy to use embodiment, only the temperature is measured and recorded, advantageously in each suction leg. The factor evaluated and the reference value are then advantageously directly temperatures.

The reference value of a given factor may be an average (typically the algebraic average) or the median of the factors evaluated for all or part of the gas circulation lines.

In order to increase detection sensitivity, it may be decided, in order to calculate the reference value, to exclude at least one of the following: the monitored gas circulation line; a gas circulation line located at one end of the ramps in the transverse direction; and the gas circulation line for which the factor is furthest away from the average, or from the median respectively.

In addition, the control process may include, as a reaction to the emission of the malfunctioning signal, triggering of measurements for safeguarding the facility.

According to a possible embodiment, safeguarding measures are triggered when the factor in a gas circulation line under consideration deviates in a given direction from a reference value, typically when said factor is lower than said reference value.

According to another possible embodiment, safeguarding measures are triggered when the relative difference between the factor in a gas circulation line under consideration and the reference value is, as an absolute value:

greater than a predetermined fixed threshold;

or greater than N times an average (typically an algebraic average) of the deviations from the average of the factors in the other gas circulation lines (where N is a real number ranging between 2 and 3);

or higher than N′ times σ (where σ is the standard deviation and N′ is a real number typically ranging between 2 and 3) of the reference value.

Advantageously, safeguarding measures are triggered only when said relative variation deviates in a given direction from the reference value, typically when said deviation is negative (i.e. typically when the factor in a gas circulation line under consideration is lower than the reference value).

According to still another possible embodiment, the pressure at the level of a point zero ramp located in the blowing zone (BL) is measured, said point zero ramp being arranged to substantially set the pressure at the junction of the blowing zones (BL) and of the heating zones (HR) to atmospheric pressure, and safeguarding measures are triggered when a time average of the deviations between said measured pressure and a reference value (typically a set point) become, as an absolute value, higher than a predetermined fixed threshold. Advantageously, safeguarding measures are triggered only when said relative time variation deviates in a given direction from the reference value, typically when it is negative (i.e. typically when the pressure measured is on average lower than the reference value). Said time average observed for each gas circulation line may possibly be compared with the actual values for some or all of the other gas circulation lines in order to trigger safeguarding measures if necessary.

It may advantageously be decided that the time average is a mobile average over the m previous measurements, where m lies between 3 and 10.

According to a second aspect, the invention relates to a control process for operating a carbonaceous block baking facility, the facility including:

a furnace which comprises hollow longitudinal partitions in which hot baking gases can circulate, and defining between them cells to receive the carbonaceous blocks to be baked,

and a heating system revolving in relation to the furnace, which comprises an upstream ramp of several legs blowing air into the various partitions, a downstream ramp of several legs sucking gas from the various partitions and, between said blowing and suction ramps, at least one heating ramp equipped with at least one burner or at least one fuel injector per partition;

basically longitudinal gas circulation lines defined in this way along the partitions between a blowing leg and a corresponding suction leg.

With the aim of detecting malfunctioning related to a combustion problem, and more particularly blocking, even partial, of a partition, the system includes:

continuous means of measurement and recording of at least one parameter, on at least one given point of each gas circulation line, chosen from: temperature, pressure, flow, oxygen concentration and carbon monoxide concentration;

means of analysis for continuously evaluating at least one factor from the measured parameter(s) and for continuously comparing this factor with a corresponding reference value;

alarm means to emit a malfunctioning signal when the comparison carried out by the means of analysis does not meet with preset safety criteria.

The malfunctioning signal is typically an electrical or optoelectronic signal, which may possibly trigger automated actions and/or generate an audible or visible alarm signal in order to trigger manual or semi-automated actions.

Several possible embodiments of the invention are described below, as nonrestrictive examples, with reference to the figures in the appendix:

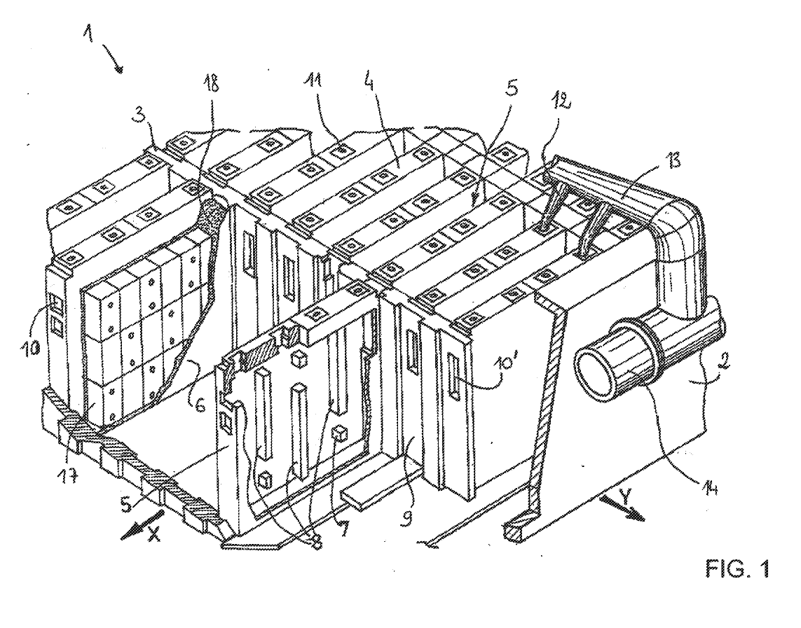

FIG. 1 is a partial perspective view of a typical anode baking facility and more particularly of the furnace of this facility;

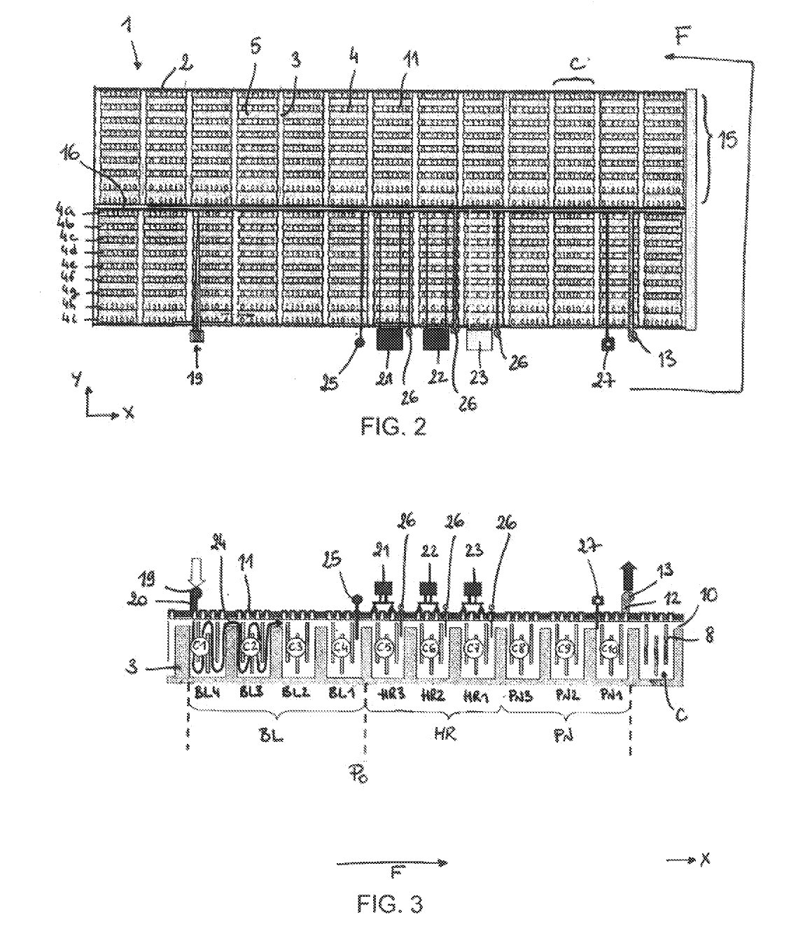

FIG. 2 is a top view of the furnace, also showing a typical heating system;

FIG. 3 is a side-view diagram showing the partitions located at the level of the heating system in FIG. 2;

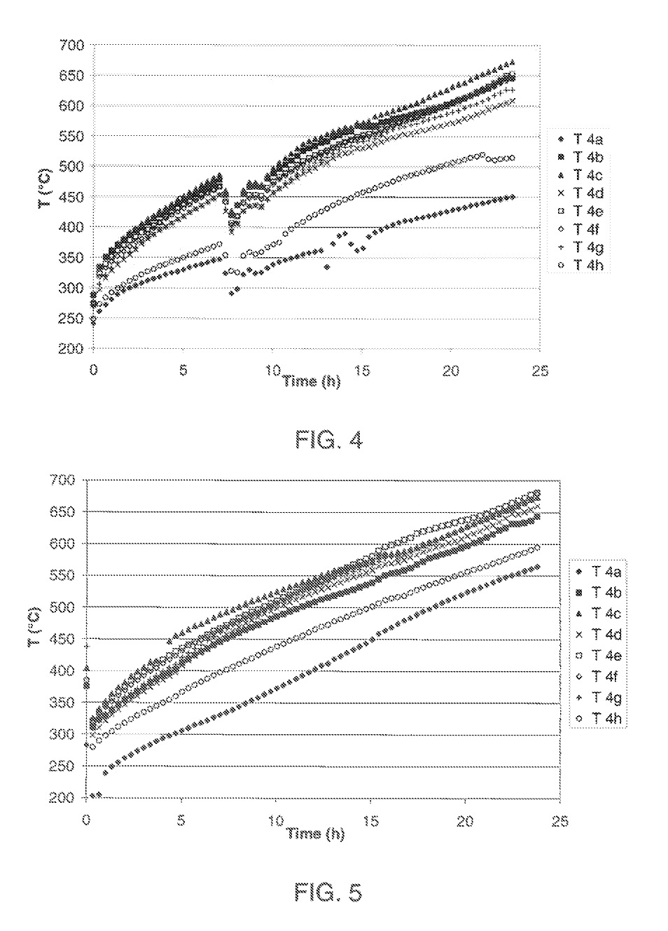

FIGS. 4, 5, 6, 8 and 10 show temperature values measured during tests. More specifically, these figures are graphs showing a change in gas temperature measured at the level of a Temperature and Pressure Ramp (TPR) in the natural pre-heating zone (PN) as a function of time, when various partitions of the same gas circulation line are blocked (the order of the figures corresponds to the distance of the blocked partition in relation to the suction ramp);

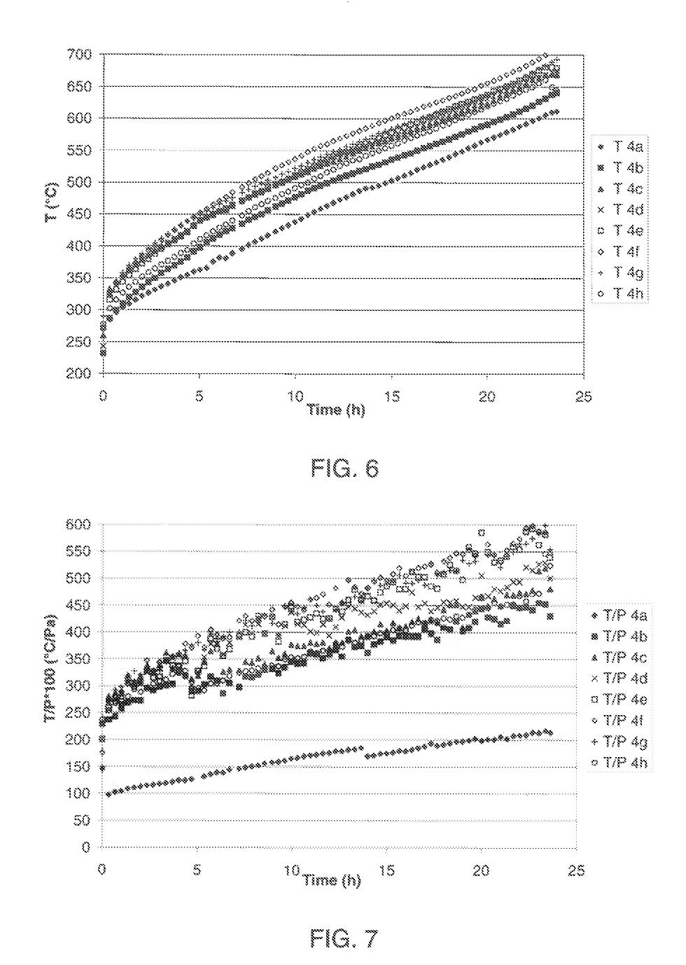

FIGS. 7, 9 and 11 are graphs showing a change in the temperature/pressure quotient at the level of the TPR as function of time, corresponding to the situations shown in FIGS. 6, 8 and 10 respectively;

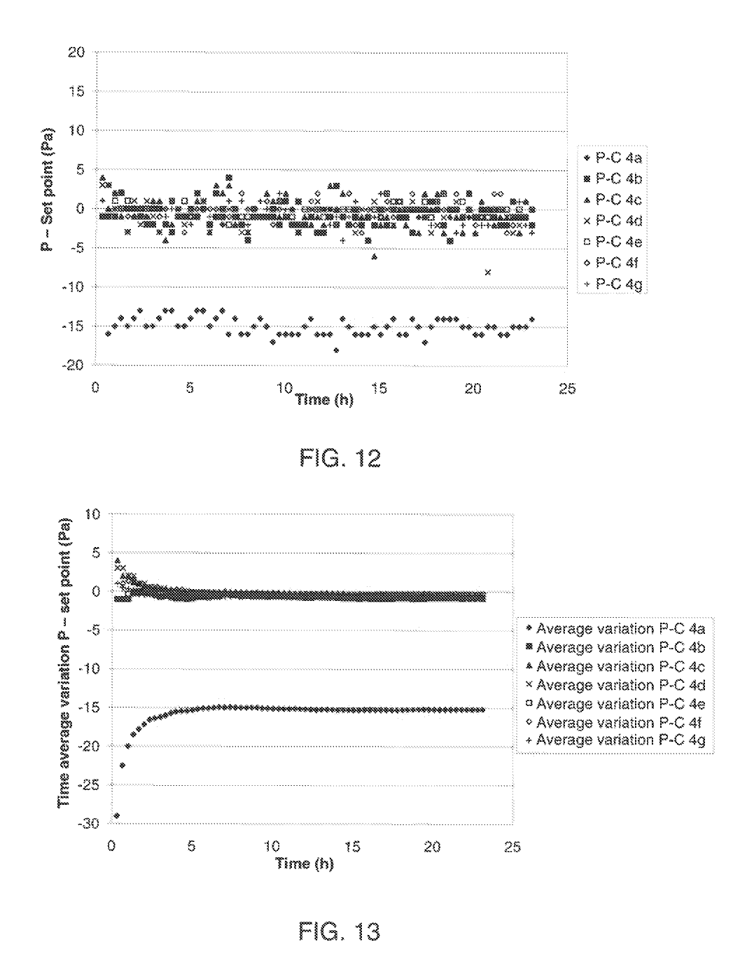

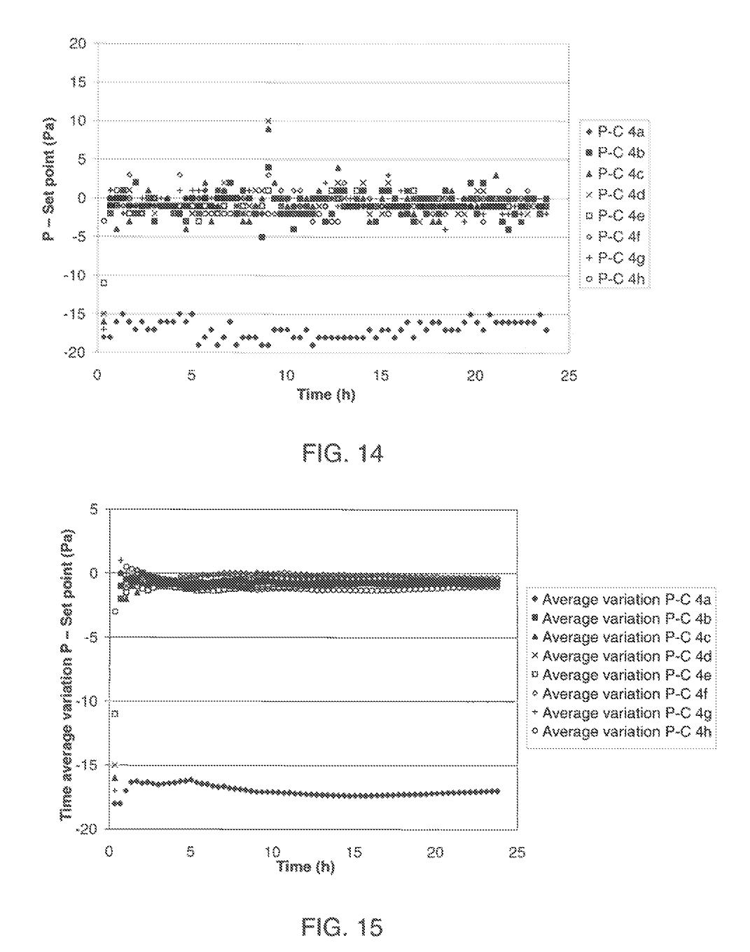

FIGS. 12 and 14 are graphs showing a change in pressure measured at the level of a point zero ramp as a function of time, when various partitions of the same gas circulation line are blocked;

FIGS. 13 and 15 are graphs showing the change in the cumulated time average of the variations in the pressure set point measured at the level of the point zero ramp as a function of time, corresponding to the situations shown in FIGS. 12 and 14 respectively.

An anode baking facility comprises a ring furnace 1. The following detailed description deals with the application of the invention to facilities including a chamber furnace, such as is illustrated in FIGS. 1 to 3. The invention is not however restricted to this type of furnace. In particular, the invention can also be applied to facilities comprising a furnace without intermediate transverse walls between the end walls.

Furnace 1 comprises an insulated enclosure 2 of substantially parallelepipedic form, in relation to which is defined a longitudinal direction X and a transverse direction Y. In enclosure 2, transverse walls 3 are placed to define successive chambers C along direction X. In each chamber C, hollow partitions 4 are placed in the longitudinal direction, forming long cells 5 between each other. Each chamber C therefore comprises several partitions 4a to 4i, as illustrated in FIG. 2.

Partitions 4 include thin side walls 6, generally separated by spacers 7 and baffles 8. The ends of the hollow partitions comprise openings 10 and are embedded in notches 9 of the transverse walls 3. These notches 9 are themselves provided with openings 10′ located in relation to openings 10 in partitions 4, in order to allow gas circulating in partitions 4 to move from one chamber C to the next. Partitions 4 also include openings 11 which are used in particular to introduce means of heating (such as injectors or fuel burners), or suction legs 12 of a suction ramp 13 connected to a main conduit 14 skirting furnace 1, or air blowing legs etc.

As can be seen particularly in FIG. 2, chambers C form a long bay 15 in the longitudinal direction, and furnace 1 typically includes two parallel bays, each being about a hundred meters long, bounded by a central wall 16. In each bay 15, there are therefore longitudinal lines of partitions 4.

In cells 5 are piled up raw carbonaceous blocks 17, i.e. anodes to be baked, and cell 5 is filled with a granular or powdery material (typically containing coke), called “packing coke” 18, which surrounds these blocks 17 and protects them during the baking process.

The anode baking facility also includes a heating system, which typically comprises: an upstream blowing ramp 19 with several air blowing legs 20 in the various partitions 4 of a chamber C (via openings 11), two or three heating ramps 21, 22, 23 each made up of one or two burners or fuel injectors per partition, and a downstream suction ramp 13 with several suction legs 12 for gas from the various partitions 4 of a chamber C (from openings 11).

As can be seen in FIG. 3, the various components of the heating system are laid out at a distance from each other according to the following typical fixed configuration: the air blowing ramp 19 is located at the entrance to a given chamber C1; the first ramp 21 of burners/injectors is placed above the fifth chamber C5 downstream of the air blowing ramp 19, the second ramp 22 of burners/injectors is placed above chamber C6 located immediately downstream of the first ramp 21; the third ramp 23 of burners/injectors is placed above chamber C7 located immediately downstream of the second ramp 22; and the suction ramp 13 is located at the outlet of the third chamber C10 downstream of the third ramp 23.

More generally, the relative position of the various elements is always the same (i.e., in the direction of the fire, the blowing ramp 19, the ramps of injectors/burners 21, 22, 23 and the suction ramp 13). However, the spacing (as a number of chambers) between elements may vary from one furnace to another. So the first ramp 21 of injectors/burners could be positioned above chamber C4 or C3. In addition, the suction ramp 13 could be located at the outlet of the second chamber downstream of the third ramp 23.

During baking operations, air is blown by the blowing legs 20. This air, mixed with primary fuel injected via the ramps of injectors/burners 21, 22, 23 and with secondary fuel produced by the baking of the anodes, circulates in the longitudinal lines of partitions 4, from chamber to chamber, following the route formed by baffles 8 and passing from one partition to another through openings 10, until it is sucked in by suction legs 12.

Between a blowing leg 20 and a corresponding suction leg 12, there is therefore a globally longitudinal line of gas circulation 24 along successive partitions 4. “Globally longitudinal”, is taken to mean that the gas circulates, from a blowing leg towards the corresponding suction leg, globally along direction X, while locally making vertical movements, typically in undulations, as illustrated in FIG. 3. As indicated above, the gas flow consists of air, gas resulting from the combustion of injected liquid or gaseous fuel, and volatile matter released by the carbonaceous blocks 17. The heat produced by the combustion of (primary) heating fuel and the volatile matter (secondary fuel) released by the carbonaceous blocks is transmitted to the carbonaceous blocks 17 contained in cells 5, which causes them to bake.

A carbonaceous block baking cycle, for a given chamber C, typically includes loading cells 5 of this chamber C with raw carbonaceous blocks 17, heating this chamber C up to the carbonaceous block 17 baking temperature (typically from 1100 to 1200° C.)′ cooling chamber C down to a temperature at which the baked carbonaceous blocks can be removed, and cooling chamber C down to room temperature.

The “ring” principle involves successively carrying out the heating cycle on the chambers of the furnace by moving the heating system. So a given chamber moves successively through periods of natural pre-heating (by hot gases circulating in the partitions), forced heating (including forced pre-heating) and cooling. The baking zone is formed by the all of the chambers located between the blowing ramp and the suction ramp. In FIGS. 2 and 3 the direction of fire F is shown.

Next, the conditions prevailing in the various chambers C of furnace 1 at the level of which the heating system is placed at a given moment are described, referring to FIGS. 2 and 3.

The first four chambers C1 to C4 along the blowing ramp 19 are known as BL blowing zones, BL4, BL3, BL2 and BL 1 respectively. There is excess pressure in these. The anodes which are placed there are already baked, and are cooled which results in increasing the temperature of the blown air which will be used for combustion. The six following chambers C5 to C10, up to suction ramp 13, are low pressure zones. Substantially at the junction 10 between these two blocks of chambers lies the “point zero” P0, i.e. a point at which the pressure in furnace 1 is substantially equal to atmospheric pressure. The point zero is located upstream of the first heating ramp in order to avoid releasing combustion products into the surrounding environment.

A pressure measuring ramp is provided—known as a point zero ramp 25 (PZR)—in order to set the pressure at the zero point. This ramp 25 is fixed in relation to the heating system, upstream of the first heating ramp 21, in the blowing zone BL. In the embodiment shown, the point zero ramp 25 is located at the level of openings 11 of partition 4 located furthest downstream of the last chamber C4, BL 1 located in the blowing zone. However, this point zero ramp 25 could be placed elsewhere in the blowing zone BL.

In the low pressure zone, the following are to be found in succession, moving from upstream to downstream:

a heating zone HR at the level of chambers C5, C6 and C7 located under the three heating ramps 21, 22, 23, including in the first two chambers C5 and C6 a forced heating zone, HR3 and HR2 respectively, then in the following chamber C7 a forced pre-heating zone HR1. The temperature of the preheated air in the blowing zones BL is enough to create ignition and combustion of the fuel;

a natural pre-heating zone PN at the level of chambers CS, C9 and C10; PN3, PN2 and PN1 respectively. The hot gases from the heating zone allow the combustible volatile matter released by the carbonaceous blocks as they are pre-heated in the pre-heating zone to ignite.

Chamber C located just after suction ramp 13 (completely to the right in FIG. 3), called the dead chamber, is a chamber ready. to receive raw carbonaceous blocks 17, which, when the heating system is moved in direction F will successively undergo: natural pre-heating (PN1, PN2 and PN3), forced pre-heating (HR1), forced heating (HR2 and HR3), and cooling (BL 1, BL2, BL3 and BL4), before the baked and cooled anodes are unloaded.

The heating system also includes a temperature measuring device which typically includes at least one pyrometer or thermocouple 26 per heating ramp and partition, each placed immediately downstream of each heating ramp 21, 22 and 23.

In addition at least one temperature and pressure ramp (TPR) 27 is provided placed between the last heating ramp 23 and the suction ramp 13, i.e. in the PN zone. In the embodiment shown in FIGS. 2 and 3, there is a single TPR used to measure both temperature and pressure. This ramp is positioned at the level of the same chamber C10 as the suction ramp 13, i.e. in the first natural pre-heating chamber PN1, for example in opening 11 the furthest upstream of this chamber.

According to a possible variant of the invention, pressure and temperature may be measured in distinct locations in the natural pre-heating zone. There is then a separate temperature measurement ramp and pressure measurement ramp. Preferably, temperature is measured in PN1, while pressure may be measured at any point in the PN zone.

Throughout the description, the expression “measurement ramp 27” or “TPR” will be employed to indicate pressure and temperature measurement, possibly in separate places, in the PN zone.

The main aim of the malfunctioning detection process for this facility is to quickly detect any blocking, even partial, of a partition, leading to a sweeping problem in this partition, i.e. with reduced or inexistent gas flow circulation. Once such a problem has been detected, suitable action for safeguarding the facility and restarting it as soon as possible, in proper safety conditions, must be taken. For this purpose, the process includes:

continuous recording of one, or advantageously of at least two, physical parameters related to the furnace and gases circulating for each line of partitions (pressure, temperature, flow, oxygen concentration, carbon monoxide concentration);

continuous evaluation, possibly by calculating, of one or more factors from the parameter(s) measured during said recording;

continuous comparison of the value of this (these) factor(s) with a reference value;

the emission of a malfunctioning signal when blocking is detected if the comparison between the factor and the corresponding reference value does not meet with the safety criterion (deviation, value above or below the threshold value).

The process additionally preferably comprises triggering of a safeguarding operation following the emission of a malfunctioning signal.

Said safeguarding operation may comprise at least one of the following operations:

triggering—ordered by the emission of the malfunctioning signal—of an alarm and/or immediate shutdown of primary fuel injection in the defective partition line;

progressive opening of the suction flaps of the partition line under consideration to maximum, as long as no impact on the other partition lines is detected (this impact being a reaction of opening the suction flaps of the other partition lines due to a loss of flow in these partition lines). If the suction flap of at least one of the other partition lines is already fully open, the opening of the suction flap of the blocked partition line is preferably not modified in order to avoid the risk of decreasing sweeping of the line of partitions whose shutter is fully open. The suction flap is a component in each suction leg, acting like a valve, and used to regulate flow (or pressure) in these legs.

The injection of primary fuel in the partition line concerned begins again, preferably after the problem has been solved (after the defective partition has been unblocked) and the facility safeguarded.

Several embodiments of the invention are described below.

According to a first embodiment, the safety criterion relates to the temperature of gases measured in the natural pre-heating zone PN, for example in the suction legs 12 or at the level of the TPR 27.

In practical terms, and according to one example, temperature T is measured and recorded in each suction leg 12, i.e. independently for each longitudinal line of partitions. The temperature in a given suction leg 12, for example for partition 4c, is compared in real-time with an average (typically an algebraic average), or the median, of the temperatures in the other partitions, including or not the external partitions 4a, 4i or the temperature furthest removed from this average or median.

If the temperature of the suction leg 12 under consideration is given as being too low, then a malfunctioning signal is emitted. In practical terms, according to different embodiment variants, this occurs if the relative difference between the temperature of suction leg 12 under consideration and the calculated average (or median) of the temperatures in the other suction legs is, as an absolute value:

higher than a fixed threshold (for example 50° C.);

or higher than N times an average of the deviations from the average of the other legs (where N is a real number typically ranging between 2 and 3);

or higher than N′ times σ (where σ is the standard deviation and N′ is a real number typically ranging between 2 and 3) of the calculated average (or median).

Said relative deviation is typically negative in the case of combustion malfunctioning in a line of partitions.

This temperature measurement is made for each line of partitions independently, so that blocking of any of the partitions may be detected quickly. Advantageously, external partitions 4a, 4i could be under dealt with differently.

This embodiment is sturdy, very reactive and very simple. It allows highly sensitive detection of a blocked partition in the natural pre-heating zone (PN) without difficulty, and optionally without calculating if so desired, even when the regulation system reacts. With this embodiment, a blocked partition in the heating ramp zone (HR) may also be detected depending on how bad the blockage is and how the control system reacts.

The change in temperature T of gases as a function of time T, in the various partition lines 4a to 4h of a furnace which, in this example, comprises eight partitions 4, is shown in FIGS. 4, 5, 6, 8 and 10. For these examples, the temperatures were recorded at the level of the measurement ramp 27 and not directly by placing a thermocouple in the suction legs 12. The results observed with these two measurement methods are comparable, but measurement directly in the suction leg is much more sensitive to a sweeping problem (blocking generally leads to an increase in suction, and therefore in negative pressure, the result of which is to increase infiltrations of cold air from the dead chamber which are directly sucked in by the suction legs). The temperature measured in the leg therefore drops still further in comparison with the temperature at the TPR which only is very slightly affected by the increase in negative pressure). In addition, a measurement made directly in the suction leg makes it possible to detect blocking in zone PN1 which is not inevitably the case with a measurement made at the TPR.

In FIG. 4 (partition 4a blocked in PN2), it can very clearly be seen that the temperature curve corresponding to this line of partitions is located far below the other temperature curves. In spite of operator action to open the flaps after a 14-hour cycle to create maximum suction, the temperature of partition 4a remained considerably lower than the temperatures of the other partitions. If the operator had not intervened, the temperature variations would have been much greater.

In FIG. 5 (partition 4a blocked in PN3), and in spite of the flaps being manually opened to their fullest extent throughout the cycle, the temperature of the blocked partition remains significantly lower than the temperatures of the other partitions.

The same applies in the case of FIG. 6 (partition 4a blocked in HR1).

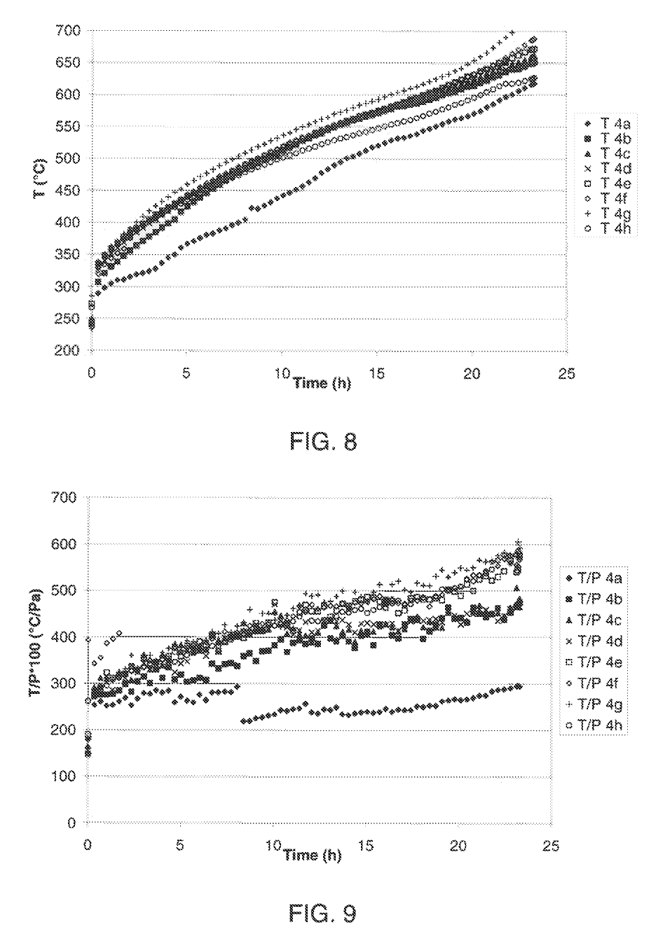

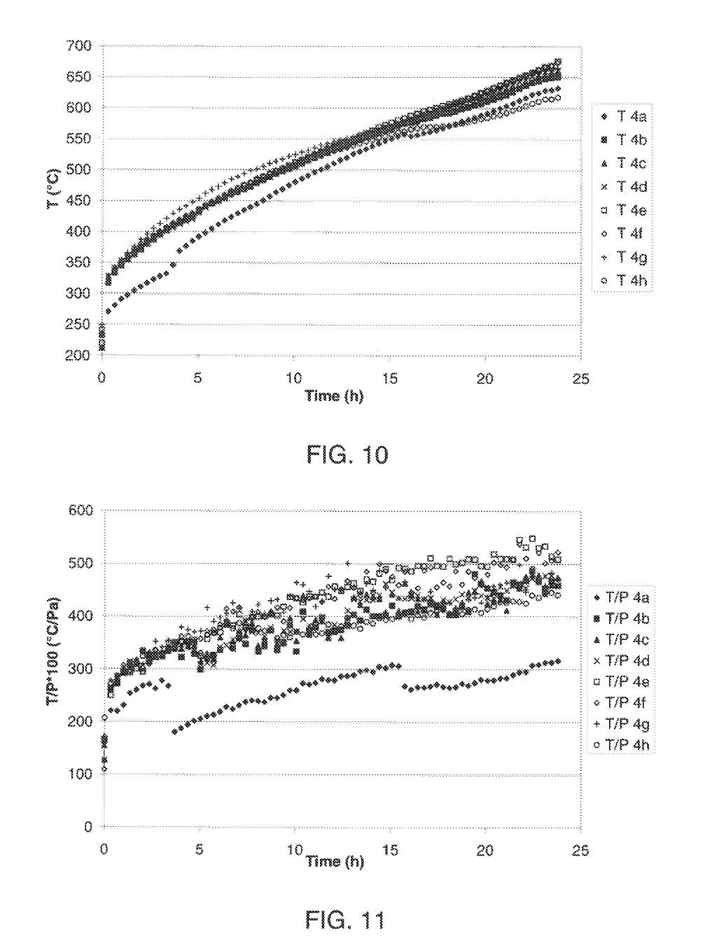

FIGS. 8 and 10 respectively illustrate the case of partition 4a blocked in HR2 and partition 4a blocked in HR3. It can also be seen that the temperature of the partition concerned is lower than the others, with a lower deviation as compared to the previous cases.

According to a second embodiment, the safety criterion relates to the T/P quotient, where

T is the temperature of gases measured in zone PN, for example in suction legs 12, and P the pressure also measured in zone PN, for example at the level of ramp 27. This is broadly the same as in the first embodiment, except that the temperature is divided by the pressure at the level of ramp 27.

This embodiment has the same advantages as those of the first embodiment. In addition, the detection of a blocked partition in the area of heating ramps 21, 22, 23 (HR1, HR2, HR3) when an automatic or manual action is carried out in order to increase suction of the line under consideration, as can be seen in FIGS. 7, 9 and 11. These figures illustrate the change in the 20 T/P ratio as a function of time T, for each line of partitions, in the same conditions as in FIGS. 6, 8 and 10, respectively. Comparison of these figures shows the greater sensitivity of the second embodiment when blocking occurs in one of the zones HR1, HR2, HR3. In this way the safety of the facility may be improved still further.

According to a third embodiment, the safety criterion relates to the pressure in zone PN, and more specifically to the pressure or the pressure gradient at the level of the micro-venturis in the suction legs 12.

For each suction leg 12, i.e. for each line of partitions, and independently, a pressure measurement is made at the entrance to the venture and a pressure tap is made in the neck of the venturi.

A first pressure switch is tripped if the negative pressure at the entrance to the venturi is too low (this being the sign of a draught problem). In addition, a second independent pressure switch is tripped if the pressure differential between the entrance and the neck of the venturi is too low (this being the sign of a low flow rate). This therefore gives a low pressure threshold and a low pressure gradient threshold. These may be fixed or variable during the baking cycle.

The main advantage of this embodiment is that it calls upon mechanical tripping, and that there are therefore no electric drives or calculations to be made. According to a fourth embodiment, the safety criterion relates to the gas output in zone PN, and particularly suction leg 12 of each line of partitions, and more particularly to the detection of a low flow threshold.

Flow Q may, for example, be calculated by measuring the difference in pressure ΔP between the entrance to a venturi in suction leg 12 and the neck of said venturi, and the temperature T of gases measured in suction leg 12, by the formula

$$Q = K \cdot \sqrt{\frac{Δ p}{T}} ,$$

, K being a coefficient defined beforehand as a function the dimensioning of the micro-venturi and of theoretical formulas.

If the calculated flow is too low, the safety system is triggered. The calculated flow may be standardized. Safety is more effective if the calculated flow is the real flow. In the same way, safety is more effective when the low flow threshold varies with time. In normal operation, the flow is not constant but varies throughout a baking cycle.

This embodiment is advantageous in that it is based on the flow, which provides the most representative image of sweeping (i.e. a circulation of fluid in the partitions).

According to a fifth embodiment, the safety criterion relates both to flow Q (calculated, for example, as indicated above for the fourth embodiment) and to temperature T of gases measured in zone PN, for example in the suction legs 12. It is possible to have two independent safety measures based on these two parameters (low threshold detection), as was explained above, or, alternatively, to regard the product Q×T as a single safety criterion.

The safeguarding measures can be made to trip when the product Q×T is lower than a reference value or when the factor in a gas circulation line under consideration is lower than n times a deviation (n being a real number, typically ranging between 2 and 3). This deviation may, for example, be the standard deviation of the reference value (i.e. an average of the other partitions) or the average of the deviations from the average of the other partitions.

This fifth embodiment makes it possible to cumulate the advantages of two embodiments relating respectively to flow/temperature, and to limit/compensate for the corresponding disadvantages.

According to a sixth embodiment, the safety criterion relates both to flow Q (calculated, for example, as indicated above for the fourth embodiment) and to quotient T/P where T is the temperature of gases measured in zone PN, for example in suction legs 12, and P the pressure also measured in zone PN, for example at the level of ramp 27 (see the second embodiment).

It is possible to have two independent safety measures based on these two parameters (low threshold detection), as was explained above, or, alternatively, to regard the product Q×T/P as single safety criterion.

This sixth embodiment makes it possible to cumulate the advantages of two embodiments (based on flow/T/P quotient), and to limit/compensate for the corresponding disadvantages.

According to a seventh embodiment, a low enthalpy threshold H=Q.CP.(T−T0) is detected. CP is the heat-storage capacity of the gas, depending on temperature. T is the temperature of gases measured in the zone PN, for example in suction legs 12, and T0 is a reference temperature. If the temperature falls due to blocking, Cp also falls which reinforces the reduction in enthalpy. Greater sensitivity is therefore obtained.

This embodiment is particularly efficient and robust.

An eighth embodiment, based on the seventh, makes it possible to improve measurement sensitivity by taking into account the pressure P measured at the level of ramp 27. The factor to be compared to a reference value is therefore H/P, where H is calculated as indicated above. This eighth embodiment is advantageous in that it makes it possible to improve detection of a blocked partition under the heating ramps (zones HR1, HR2, HR3).

According to a ninth embodiment, the safety criterion is based on the pressure measured at the level of the point zero ramp 25 (PZR), i.e. on the “pressure at point zero” P0.

When the value of the point zero is controlled automatically during a baking cycle by varying the air flow blown by blowing ramp 19, the reference value under consideration is the time average of the deviations in pressure set points for the line under consideration. In normal operation, this average is very similar from one partition line to another; it reaches a value close to 0 Pa early on in the baking cycle, then varies little during a baking cycle. Safeguarding measures are triggered when the average time deviation in pressure P at point zero of the partition under consideration is negative and lower than a low threshold of negative variation (for example −10 Pa). The time average may be an average of measurements since the beginning of the cycle. Preferably, the time average is a mobile average based on a certain number of previous measurements, typically the last 5 measurements, in order to increase detection reactivity.

When point zero is not controlled, the safety criterion is the value of pressure PO at point zero. This value makes it possible to detect a partition blocking problem or a problem of controlling air blown by blowing ramp 19 by defining a low threshold of around −10 Pa.

This embodiment is very simple, sturdy, and reactive. It is particularly efficient and effective for detecting a blocked partition at the level of the BL blowing zone because it adapts to all systems (point zero regulation or fixed blowing). This embodiment also makes it possible to detect a blocked partition under the heating ramps.

In FIG. 12, which shows the pressure measured at point zero on the various partition lines, it can be noted that, for the blocked line of partitions (here partition 4a of chamber BL 1 is blocked), the pressure variation from the set point is greater.

By considering the time average of the variations from the set point as a function of time (FIG. 13), detection may be still further refined, because this average makes it possible to remove the variations in time of deviations from the set point, so that the variation between normally functioning partition lines and the partition line with the blocked partition becomes linear and constant.

In FIGS. 12 and 13 the values concerning partition 4h do not appear because, unlike the other partitions, this partition 4h was not controlled automatically during the test, and the values obtained are therefore not significant.

FIGS. 14 and 15 are the equivalents of FIGS. 12 and 13 respectively, if the blocked partition is partition 4a in chamber BL2.

A tenth embodiment has at least one O2 and/or CO analyzer per fire, each partition being connected to this analyzer. This analyzer is generally placed in zone PN, downstream of the heating ramps, typically at the level of chambers PN1 or PN3 or in the suction legs. For example, when a single analyzer is used, the analyzer successively sweeps each partition for 10 minutes, for example, to sample gas and make an analysis, throughout the baking cycle. If the O2 level becomes too low and/or the CO level too high, the safety system is triggered. This embodiment is effective for checking that the fuel injected by heating ramps 21, 22, 23 (in HR1, HR2, HR3) is burning properly.

The calculation of various factors and comparison of each one of these factors with a corresponding reference value may of course be combined. In this way, the user may benefit from the advantages of each embodiment and limit/compensate for the possible disadvantages of these embodiments.

A particularly advantageous embodiment of the invention, therefore, involves combining a first safety criterion based on pressure P with the point zero P0 and one or more other safety criteria. It may be any of the above embodiments. This makes it possible simply to detect a blockage anywhere between the blowing ramp and the suction ramp, since the PO criterion is particularly effective for detect blocking in the blowing zone BL and the other criteria are particularly effective for detecting blocking in zones HR and PN.

For example, the safety criterion is based both on pressure P at point zero P0 and temperature T of gases measured in zone PN, in particular in the suction legs 12.

This is a particularly simple and effective embodiment. Because of the monitoring of temperature T, it is possible to detect a blocked partition in the natural pre-heating zone (PN) and the heating ramp zone (HR); additionally, because of the monitoring of pressure P at point zero PO, it is possible to detect a blocked partition in the blowing zone (PN). In this way, the entire furnace 1 is made safe.

As a variant, the factors pressure P at point zero P0 and quotient T/P may be combined (see the second embodiment).

In this way the invention makes a significant improvement to prior art, by providing a process for detecting malfunctioning of an anode baking facility which makes it possible to detect local blocking, i.e. a blockage in a particular partition, anywhere between the blowing ramp and the suction ramp. This result is in particular obtained by continuous measurement and monitoring of local parameters for each line of partitions. Unlike a system which measures a global parameter, there is no compensation effect which would mask the existence of a problem.

It goes without saying that the invention is not limited to the embodiments described above as examples but, on the contrary, encompasses all the variations of embodiment.

1. Control process for the operating of a carbonaceous block baking facility, the facility comprising:
a furnace which comprises hollow longitudinal partitions in which hot baking gases can circulate, and defining between them cells to receive the carbonaceous blocks to be baked,
and a heating system, revolving in relation to the furnace, which comprises an upstream ramp of several blowing legs blowing air into the various partitions, a downstream ramp of several suction legs sucking gas from the various partitions and, between said blowing and suction ramps, at least one heating ramp equipped with at least one burner or at least one fuel injector per partition;
basically longitudinal gas circulation lines being defined in this way along the partitions between a blowing leg and a corresponding suction leg;
characterized in that, with the aim of detecting even partial blocking of a partition, the process includes:
a) for each gas circulation line, continuous recording, on at least one given point of said the gas circulation line, of at least one measured parameters selected from a group consisting of: temperature, pressure, flow, oxygen concentration and carbon monoxide concentration;
b) continuous evaluation of at least one factor from the at least one measured parameter(s);
c) continuous comparison of the at least one factor with a corresponding reference value; and
d) emission of a malfunctioning signal when the comparison between the at least one factor and the corresponding reference value does not meet with the predefined safety criteria.

2. Process according to claim 1, characterized in that at least two parameters are measured, each one in a distinct zone of the furnace chosen from a group consisting of:
a natural pre-heating zone, located upstream of the at least one heating ramp;
a heating zone, located under the at least one heating ramp;
a blowing zone located downstream of the at least one heating ramp.

3. Process according to claim 1, characterized in that at least one parameter is measured in a natural pre-heating zone or a heating zone, and at least one parameter is measured in a blowing zone.

4. Process according to claim 3, characterized in that the parameter measured in the blowing zone (BL) is the pressure at a level of a point zero ramp which is arranged so as to substantially set the pressure at the junction of the blowing zones and of the heating zones to atmospheric pressure.

5. Process according to claim 1, characterized in that at least one factor evaluated is directly a measured parameter.

6. Process according to claim 1, characterized in that at least one factor evaluated is a function of at least two parameters.

7. Process according to claim 1, characterized in that at least one factor is chosen from a group consisting of: T, T/P, P, Q, Q×T, Q×T/P, H=Q.Cp.(T−T0), HIP, P0, O[2], [CO], where:
T is the temperature at a point on a gas circulation line;
P is the pressure at a point on a gas circulation line;
Q is the gas flow rate at a point on a gas circulation line;
Cp is a heat-storage capacity of the gas;
T0 is a reference temperature;
P0 is the pressure measured at a level of a point zero ramp which is arranged to substantially set the pressure at the junction of blowing zones (BL) and of heating zones to atmospheric pressure;
[O2] is the oxygen concentration;
[CO] is the carbon monoxide concentration.

8. Process according to claim 1, characterized in that at least two distinct factors are evaluated, and in that each of these factors is compared with a distinct corresponding reference value.

9. Process according to claim 1, in which at least one measured parameter is the temperature.

10. Process according to claim 9, in which the temperature is measured in the suction leg.

11. Process according to claim 9, in which at least one evaluated factor is directly the temperature.

12. Process according to claim 1, characterized in that the reference value of a given factor is an average or a median of the factors evaluated for some or all of the gas circulation lines.

13. Process according to claim 12, characterized in that, to calculate the reference value, at least one of the following is excluded, selected from a group consisting of: the monitored gas circulation line; a gas circulation line located at one end of the ramps in the transverse direction; and the gas circulation line for which the factor is furthest away from the average, or from the median respectively.

14. Process according to claim 1, characterized in that the process additionally includes, as a reaction to the emission of the malfunctioning signal, triggering of measures to safeguard the facility.

15. Process according to claim 14, characterized in that safeguarding measures are triggered when a relative difference between the factor in a gas circulation line under consideration and the reference value is, as an absolute value:
greater than a predetermined fixed threshold;
or greater than N times an average of deviations from an average of the factors in the other gas circulation lines (where N is a real number ranging between 2 and 3);
or greater than N′ times cr (where cr is a standard deviation and N′ is a real number ranging between 2 and 3) of the reference value.

16. Process according to claim 14, characterized in that safeguarding measures are triggered when the factor in a gas circulation line under consideration deviates in a given direction from the reference value.

17. Process according to claim 14, characterized in that the pressure at the level of a point zero ramp located in the-a blowing zone is measured, said point zero ramp being arranged to substantially set the pressure at a junction of the blowing zones and of heating zones to atmospheric pressure, and in that safeguarding measures are triggered when a time average of deviations between said measured pressure and a reference value becomes, as an absolute value, higher than a predetermined fixed threshold.

18. Process according to claim 17, characterized in that the time average is a mobile average over the m previous measurements, where m lies between 3 and 10.

19. Process according to claim 17, characterized in that safeguarding measures are triggered when the said time average deviates in a given direction from the reference value.

20. Control system for a carbonaceous block baking facility, the facility comprising:
a furnace which comprises hollow longitudinal partitions in which hot baking gases can circulate, and defining between them cells to receive the carbonaceous blocks to be baked,
and a heating system, revolving in relation to the furnace, which comprises an upstream ramp of several blowing legs blowing air into the various partitions, a downstream ramp of several suction legs sucking gas from the various partitions and, between said blowing and suction ramps, at least one heating ramp equipped with at least one burner or at least one fuel injector per partition;
basically longitudinal gas circulation lines defined along the partitions between a blowing leg and a corresponding suction leg.
characterized in that, with the aim of detecting even partial blocking of a partition, the system includes:
continuous means of measurement and recording of at least one parameter, on at least one given point of each gas circulation line, chosen from a group consisting of: temperature, pressure, flow, oxygen concentration and carbon monoxide concentration;
means of analysis for continuously evaluating at least one factor from the at least one measured parameter and for continuously comparing the at least one factor with a corresponding reference value;
alarm means to emit a malfunctioning signal when the comparison carried out by the means of analysis does not meet with preset safety criteria.
